(19) United States
(12) Patent Application Publication
(10) Pub. No.: US 2017/0333959 A1
(43) Pub. Date: Nov. 23, 2017

(54) MILTER HIGH PRESSURE OZONE BOOST FOR IN-SITU REMEDIATION

(71) Applicant: PIPER Environmental Group, Inc., Gastroville, CA (US)

(72) Inventors: Jane I. Piper, Monterey, CA (US); Hasse Milter, Sorø (DK); Joshua T. Salvage, Soquel, CA (US)

(21) Appl. No.: 15/160,419

(22) Filed: May 20, 2016

Related U.S. Application Data
(63) Continuation-in-part of application No. 15/158,455, filed on May 18, 2016, now abandoned.

(51) Int. Cl. B09C 1/00; B09C 1/08; C02F 1/78; C02F 1/72; C02F 103/06; C02F 101/32

(52) U.S. Cl. CPC B09C 1/002; C02F 1/78; C02F 1/727; B09C 1/08; B09C 2101/00; C02F 2101/32; C02F 2103/06; C02F 2303/04

(57) ABSTRACT

A method for treating contaminant within contaminated soil and groundwater, especially deep aquifers, through in situ oxidative remediation of the contaminant by sparging, wherein the method includes multiple injection wells, injecting an oxidizing multi gas comprised of high concentration ozone gas (10-20% ozone by wt., 75-85% oxygen) at pressures up to 500 psi (34.5 bar) to reach well depths in excess of 1100 feet (335 meters) and when necessary compressed ambient air at pressures up to 500 psi (34.5 bar).

### FIELD OF INVENTION

The present invention relates generally to ozone in situ water remediation systems where ozone gas, oxygen gas, or any mixture of ozone, oxygen, and/or air is injected in gaseous form into subsurface. Any single or combination of gas listed above is hereinafter called “oxidizing gas.” Traditional in situ water remediation technologies delivery pressures, when comprised of ozone gas, has historically been the limiting factor due to ozone generator output pressure. This invention is typically to be utilized where injection pressures above 43.5 psi (3.0 bar) is required, although can be utilized for lower pressure ozone generator outputs.

### BACKGROUND OF THE INVENTION

There is a well-recognized need for removal of subsurface contaminants that exist in deep aquifers as well as in subsurface lithology with low porosity such as high back pressure produced in tightly packed soils, sediments, clay, and rock. Subsurface lithology with low porosity and high back pressure, hereinafter referred to as “subsurface lithology.” Contaminants typically include various semi volatile (SVOC) and volatile (VOC) organic compounds, hydrocarbons including chlorinated hydrocarbons, tetrachloroethylene, trichloroethylene, cis 1,2-dichloroethane and vinyl chloride (to name a few). Other common contaminants include benzene, leachate, toluene, methylbenzene, xylenes, petroleum hydrocarbons, naphthalene, polyaromatic hydroarbons, and explosives such as TNT and RDX. Many emerging contaminants such as 1,4-Dioxane, pesticides, Pharmaceutical wastes including “endocrine disrupters”, and daughter products, such as TBA (from MTBE), can also be remediated. These contaminants can be in areas that require gas delivery pressures greater than 43.5 psi (3.0 bar), thus there is a need for higher pressure ozone injection for remediation.

U.S. Pat. No. 5,221,159, discloses a method and apparatuses for removing contaminants from soil and an associated subsurface groundwater aquifer, Billings shows injection of air into aquifers to encourage biodegradation of leachate plumes in conjunction with simultaneous soil vacuum extraction.

U.S. Pat. No. 8,302,939, discloses a method for treating contaminants at a site, especially a deep well site, includes delivering a first stream of a first gas to a first port of a laminar microporous diffuser and delivering a second stream of a second gas to a second port of the laminar microporous diffuser, Kerfoot shows injection of ozone into wells at a vertical depth in excess of 180 feet (54.8 meters) from the surface of the earth.

### BRIEF SUMMARY OF THE INVENTION

A method of decreasing contaminants of concern (COC) concentration within contaminated soil, sediment, rock, clay, etc. and/or groundwater through in situ oxidation is provided. This is accomplished by oxidizing gas sparging, wherein the method includes single or multiple injection wells extending to deep underground aquifers or subsurface lithology which has high backpressure and injecting an oxidizing gas comprised of high concentration ozone (preferably 10-20% ozone by weight, 75-85% oxygen) and when needed to accomplish the desired gas flow, compressed air, both at pressures up to 500 psi (34.5 bar). Single or multiple gases can be injected using this methodology; these gases may be ozone alone, ozone plus compressed air, or oxygen, defined as “oxidizing gas.”

In a first aspect, the invention relates to well high pressure oxidizing gas sparging method for in situ sparging for remediation or chemical degradation and removal of contaminants in soil and groundwater, comprising: delivering an oxidizing multi-gas into a well screen.

Preferably, the method further comprises: coupling an inlet port to a well screen.

Preferably, the method further comprising: coupling a boost tank's off-gas to inlet port on a well screen, typically interconnected by a length of riser piping and intermediate piping.

The method may further comprise coupling an ozone generator to supply ozone gas to an injector, such as a Mazzei injector, circulating DI water in boost tank; and coupling air compressor to supply compressed ambient air to boost tank.

In preferred embodiments, the method may further comprise arranging the ozone generator and the air compressor so that the ozone generator gas supply is the primary gas source, the compressed ambient air is only added, in limited quantities, as a buffer to balance the fluctuations in wellfield backpressures.

In accordance with preferred embodiments, the method may further comprise supplying the ozone at a flow rate of 0.1-43.3 CFM (2600 CFH or 1227 LPM) at 0 to 43.5 psi (0-3 bar) into the injector, such as the Mazzei injector, which has water outlet pressure of 500 psi (34.5 bar) into boost tank and supplying compressed air at a flow rate of 0.1-21.65 CFM (1300 CFH or 613 LPM) at up to 500 psi (34.5 bar) into boost tank.

Preferably, ozone mixed with oxygen and compressed ambient air is used to form multi-gas, at well site.

Preferably, the method may further comprise disposing the well screen into a well that is contaminated.

In preferred embodiments, each boost tank and the injector, such as the Mazzei injector system may be configured to handle up to 8 CFM (480 CFH or 226.5 LPM) of total gas flow each and when needed, wherein multiple boost tanks and injectors such as Mazzei injectors will be used in parallel to achieve targeted flow rates.

Preferably, the method may further comprise disposing the well screen into a well at a depth in excess of 1100 feet (335 meters) below ground surface or with backpressure greater than 44 psi (3.03 bar) requiring output above gas generator manufactures rated 0 to 43.5 psi (0-3 bar).

Further, the method may further comprise of multiple injection wells.

Advantageously, the method may further comprise emitting multi-gas through well screen small openings into aquifer.

Preferably, the oxidizing gas is ozone and/or is oxygen

In preferred embodiments, the boost tank may incorporate internal cooling coils (a heat exchanger) to maintain acceptable water temperatures to increase ozone solubility and reduce ozone decomposition due to elevated temperatures.

Further, the boost tank may or may also incorporate external cooling jacket to reduce water temperatures to increase ozone solubility and reduce ozone decomposition due to elevated temperatures.

In preferred embodiments, the boost tank may incorporate internal demisting-baffles to reduce moisture carry over from saturated-gas leaving tank through boost tank outlet valve.

Preferably, the boost tank may incorporates automatic DI water and/or reverse osmotic water addition when boost tank water level is low.

Preferably, the boost tank may incorporate acid rinse and passivation of all welds during its construction.

Preferably, the injector, such as the Mazzei injector, mixes ozone gas into DI water until the water is fully saturated with ozone gas, resulting in off-gassing any additional ozone at the pressure of the ozone saturated DI-water inside the boost tank.

In a second aspect, the invention relates to a system for pressurizing an oxidizing agent, such as ozone and/or oxygen, preferably to a pressure above 43.5 psi (3.0 bar), the system preferably comprising a tank (also referenced a boost tank herein) and an injector, such as a Mazzei injector. The injector preferably comprises:
a liquid inlet for inletting pressurized liquid into the injector,
an injector suction port for inletting oxidizing gas into the injector, and
an outlet port connected to the tank for outletting the pressurized liquid and oxidizing agent, such as ozone, into the tank;

The system may further comprise a pump (also referenced a circulation pump herein) adapted to pressure a fluid to a pressure above 43.5 psi (3.0 bar) and having:
a pump inlet in fluid connection with the interior of the tank, and
a pump outlet in fluid connection with the liquid inlet of the injector,
   wherein the tank further comprising a pressurized oxidizing gas outlet for outletting pressurized oxidizing gas from the tank.

The pump may preferably be configured to provide the pressure needed for pressurizing the oxidizing agent. However, in some preferred embodiments, the pump is configured for providing for 80-90% of the total pressure. In some preferred embodiments, the pressure at the mazzei injector outlet pressure should be as high as 450 psi. The rest of the pressure (last 50 psi to get to 500 psi total), may then come from an air pressure regulator (see below). Typically, the oxidizing agent (gas) starts at 43.5 psi—fed into the Mazzei gas inlet port, then is pressurized to as high as 450 psi (same pressure as the water leaving the mazzei).

A system according to preferred embodiments of the invention may further comprise a water inlet for inletting water, preferably deionized or reverse osmotic water into system.

Preferably, the water inlet connection pipe is provided in the tank for inletting water, preferably deionized water or reverse osmotic water, into the tank.

Preferably, the system may further comprise a connection pipe for feeding pressurized oxidizing agent to a well, and the pressurized oxidizing gas outlet is in fluid communication with the connection pipe.

A system according to preferred embodiments of the invention, may further comprise a valve, such as a shut-off valve, arranged in the fluid connection between the connection pipe and the pressurized gas outlet for controlling the flow of pressurized oxidizing agent from the tank and to the connection pipe.

Preferably, the connection pipe may be in fluid communication with the with an source of oxidizing agent through a valve such as a shut-off valve, for controlling a flow of oxidizing agent directly into the connection pipe.

Preferably, the system further comprises a heat exchanger for extracting or for the addition of heat to a fluid present in the system, the heat exchanger being preferably arranged inside the tank.

A system according to preferred embodiments of the invention may further comprise a mass controller configured to operate the opening position of the valve arranged in the fluid connection between the connection pipe and the pressurized gas outlet, the mass controller being configured to sense flow through the valve and actuate the valve to various positions to achieve desired final output.

Unlike the prior art, contaminated soil, rock, clay-mix or groundwater is injected with an oxidizing gas, wherein this is injected into wells deeper or with higher backpressure than existing technologies currently allow. By boosting the ozone gas in this unconventional way, leak prone apparatus required with ozone-resistant boost compressors are replaced with a more robust method to create injectable ozone gas pressures up to 500 psi (34.5 bar). Additionally, injection into individual wells may have different backpressure and the invention automatically adjusts to appropriate gas flow and pressure to achieve desired injection. Ozone gas pressures at this level are capable of reaching well screen depths in excess of 1100 feet (335 meters) below top of underground water column if no other backpressure exists or into shallower subsurface lithology where there is a high backpressure due to low porosity. Previous to this invention, existing technologies were limited to wells in excess of 180 feet (54.8 meters) from the earth's surface with no backpressures. [U.S. Pat. No. 8,302,939—Kerfoot: Soil and water remediation system and method, herein expressly incorporated by reference in its entirety]. This depth potential is reduced when injection into dense sediment, rock, fractured bedrock, clay mixture, or glacial-till is targeted due to the backpressure from subsurface lithology. However, this injection does not require blended compressed air to achieve goal, thus yielding the highest possible concentration of ozone. This is a desirable feature, which allows higher concentration ozone to come into contact with contaminants of concern to oxidize effectively and more rapidly.

The present invention utilizes proven ozone and water mixing technology in an ozone boost tank to increase the pressure of the water inside the boost tank up to 500 psi (34.5 bar), and thus any ozone that is mixed into the water will also rise to this pressure of 500 psi (34.5 bar). The boost tanks' primary function is as an off-gas or “flash” reaction chamber while also controlling the off-gas flow and pressure through a mass flow control valve on the gas outlet of the boost tank. Key to this methodology is the process control logic associated with the boost system.

Another key to the ozone boost tank, is its ability to keep the water cool. By utilizing an industrial water chiller into the system design, the boost tank has internal coils of tubing carrying chilled water as well as the exterior of the boost tank will be jacketed with additional space for the chilled water to flow. Ozone degrades when exposed to elevated temperatures and by maintaining boost tank chilled water as low as possible by setting the chiller temperature to 37.4 deg. F. (3 deg. C.) our boost system preserves the ozone gas at the highest concentration possible.

### BRIEF DESCRIPTION OF THE SEVERAL VIEWS OF THE DRAWING

The present invention and preferred embodiments thereof will now be described in more detail with regard to the accompanying figures. The figures show ways of implementing the present invention and are not to be construed as being limiting to other possible embodiments falling within the scope of the attached claim set.

FIG. 1—Is an exterior elevation schematic illustration showing ozone boost tank and all connection points.

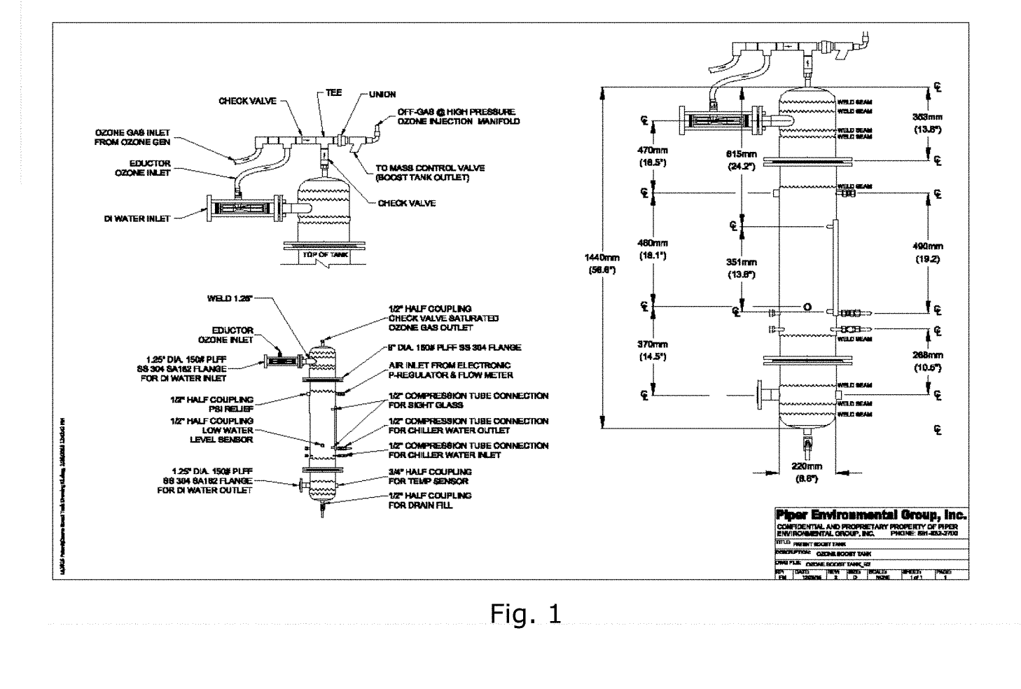

FIG. 2—Is an interior schematic illustration showing ozone boost tank top portion internal degassing baffle design.

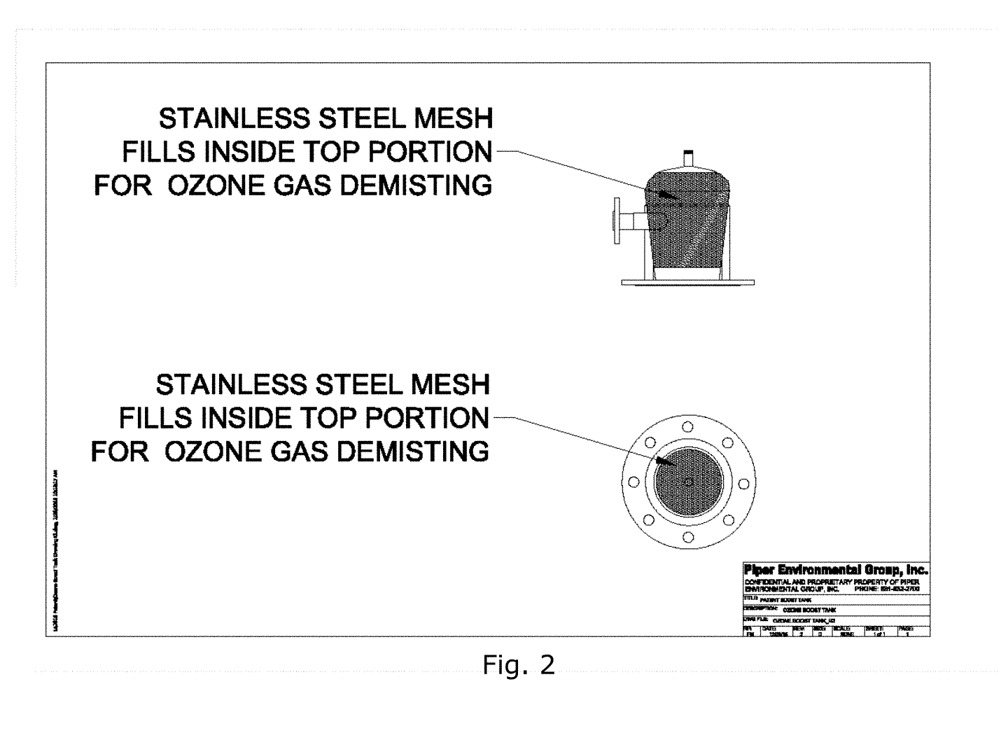

FIG. 3—Is an interior schematic illustration showing ozone boost tank middle portion internal cooling coil for DI water temperature control.

FIG. 4—Is a photo of ozone boost tank 2 and major components and locations according to a preferred embodiment; as illustrated the boost tank system preferably comprises six main components: Boost tank 2 with internal cooling circuit 8. Mass control effluent valve (boost tank outlet valve 5)—in the preferred embodiments, the control is performed by a computer (PLC) which control the flow through the outlet valve 5, typically by controlling the degree of opening of the valve (between fully open and fully closed). 9 Circulation Pump. 1. Ozone Mazzei injector/Injector. 15 Air pressure regulator (with valve)—for adding pressure boost.

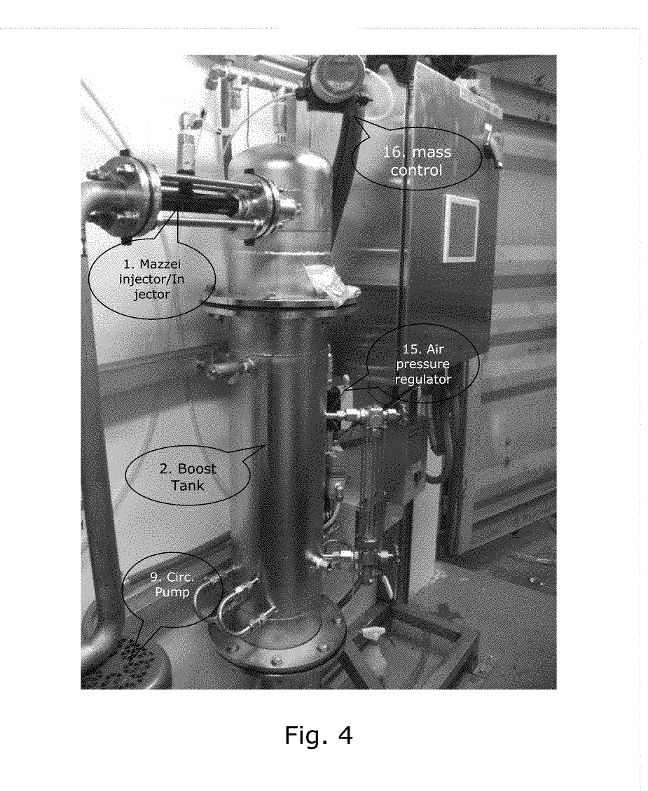

FIG. 5—is a schematic illustration of a system for pressurizing ozone according to a preferred embodiment of the invention;

### DETAILED DESCRIPTION OF THE INVENTION

The present invention relates in particular, but not exclusively, to using oxidizing gas in sparge systems for injection into various subsurface lithology (soil, fractured bed-rock, clay or aquifers) to remediate contaminant plumes in situ where pressure above 3.0 bar (43.5 psi). Preferred embodiments, of the method (or process) of the present invention, employs traditional ozone gas production and an injector 1 such as an Mazzei injector gas mixing technology, combined with a water vessel (tank) 2 to boost ozone gas delivery pressures (up to 500 psi or 34.5 bar), as often required to remediate deep contaminated aquifers at depths in excess of 1100 feet (335 meters) below the top of the water column if no other backpressure present or into less deep higher backpressure formations due to lithology that features high-density porosity.

Gas traveling down through a column of water requires 0.43 psi (0.03 bar) of pressure to displace it 1 foot (0.3 meter) of elevation, previous ozone sparging systems were limited to depths of in the range of 180 feet (54 meters) or less. Further, the pressure of the water column may not be the only pressure to overcome in order to inject oxidizing gas as there may be additional back pressure or pressure loss from the material of the soil, e.g due to the soil comprising clay rocks etc.

Current ozone gas remediation systems rely on addition of compressed air to bring sparge pressure up beyond the ozone generator rated capacity output of 0-43.5 psi (0-3.0 bar) or the addition of an ozone resistant boost compressor which is capable of boosting pressure up to 50 psi (3.45 bar). This is due to the pressure restriction of all ozone generators. Most ozone generators operate at a vacuum or 15-20 psi (1.03-1.38 bar) so current ozone generators require an ozone pressure boost. The majority of ozone generators operate as described above with output pressure of 0-20 psi (−1.38 bar); the maximum and preferred ozone generator output is 43.5 psi (3.0 bar). While few generators are able to withstand 100 psi (6.9 bar), it should be noted that running these generators at their maximum pressures causes significant reductions in ozone generator performance.

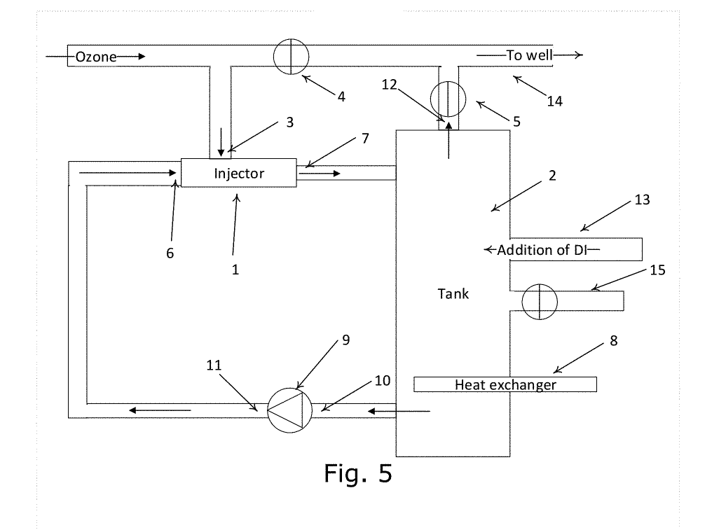

In preferred embodiments, the present invention delivers ozone gas at 0.00-43.5 psi (0.00-3 bar), to Mazzei injector suction port 3, specifically designed for injector outlet water pressure up to 500 psi (34.5 bar) (variable by design to fit the application); and by saturating pure water with ozone gas until ozone saturation limit is achieved, and the recirculation water cannot hold dissolved ozone gas. From that point, ozone gas added through Mazzei injector “flashes” and becomes off-gas. This invention supplies saturated off gas ozone at up to 500 psi (34.5 bar). If gas pressures required to inject into a well are lower than ozone generator output pressure, no boost is required and dry ozone gas may bypass the Mazzei and boost tank and go directly into the wells. Accordingly, lower ozone output pressures of 2.3-3.0 bar (33.4-43.5 psi) may be preferred. In such cases, valve 4 is operated into its open position and the valve 5 is operated into its closed position (see e.g. FIG. 5).

According to the present invention and unlike prior art methods, the contaminated groundwater is preferably injected with oxidizing gas typically at pressures beyond the limits imposed by ozone generators and ozone-resistant pressure booster pumps; plus higher ozone gas concentrations are achieved. Previous injection pressure limitations generally kept ozone sparging well pressures at 50 psi (3.4 bar) and rare instances up to 100 psi (6.9 bar) as previously noted.

In the present invention, the high pressure boost system will deliver ozone gas at pressures up to e.g. 500 psi (34.5 bar), and eliminate traditional ozone gas compression technologies. Previous systems have relied on a maximum ozone gas pressure, and this maximum pressure is set by each ozone generator. The inventor is aware the critical pressure for ozone is 807.9 psi (55.7 bar), which is why invention remains safe at no more than 500 psi (34.5 bar). The inventor is also aware of previous research done in ozone stability at pressures up to 290 psi (20 bar) [Gas Encyclopedia. Air Liquide. Web. 16 Feb. 2016.].

According to preferred embodiments of the invention ozone gas from the ozone generator is fed into Mazzei injector's 1 gas suction port 3 at maximum flow and pressure allowable by the ozone generator and Mazzei. The Mazzei injector 1 is flowing water through its water inlet 6 and outlet ports 7 which allows the water and ozone to mix. Ozone generator and Mazzei injector 1 selection criteria are based on desired pressure and gas flow output, which are driven by site specific conditions. Limiting factors to consider may be: maximum air pressure will be limited by air compressor; this present design is intended to be as high as 500 psi (34.5 bar). Additional features include a gas flow meter signal from ozone generator and an air flow measurement of the compressed air being added directly to the tank, if necessary to achieve desired output. These two measurements are added together, if needed, to determine final airflow output. Ideal design does not require additional compressed air.

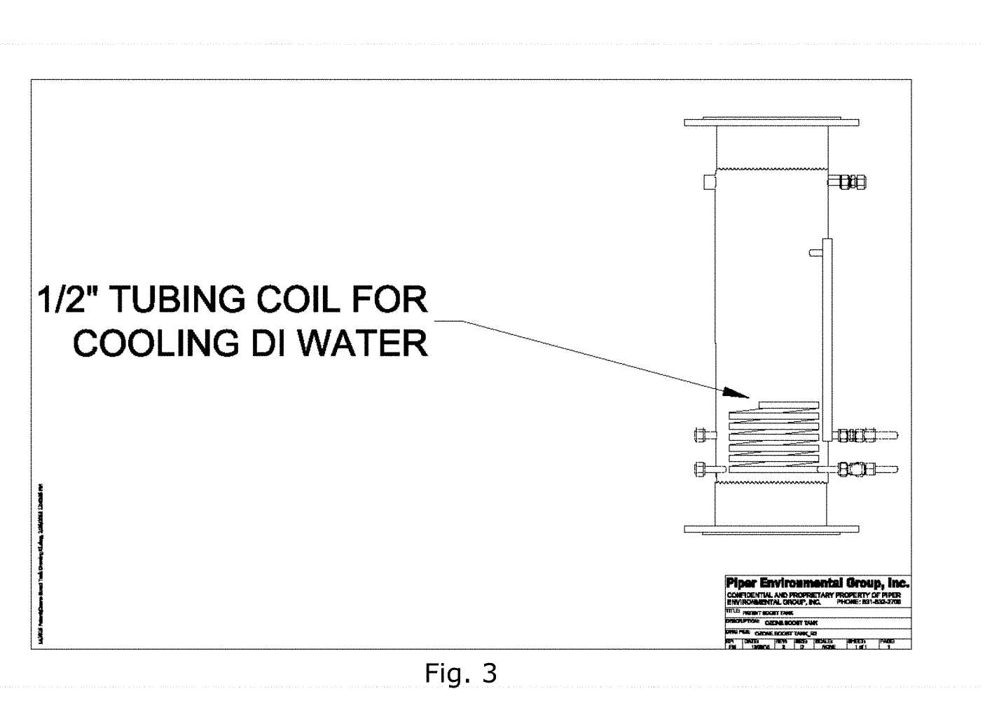

Water quality inside the boost tank 2 is preferably of upmost importance and often requires pure water which is free of minerals and that will precipitate at high pressure when introduced to ozone. Thus, it is generally preferred to use DI water (De-Ionized Water). Such precipitation will occur more rapidly as temperatures increase. Therefore, tank cooling is often critical. To meet this objective, the tank will typically incorporate a heat exchanger preferably in the form of internal cooling coils (see e.g. FIG. 3) as well as utilize a cooling water jacket (not illustrated) on the tank 2, if warranted. Another issue stemming from using non-pure water inside the boost tank 2 is the contaminant carry-over can cause issues with precipitation in control valves, injection valves, injection manifold, and well head components.

The ozone boost tank 2 must be carefully constructed so that the tank 2 won't corrode or leak under high pressures. One common mode of corrosion in corrosion-resistant stainless steels is when small spots on the surface begin to rust because grain boundaries or embedded bits of foreign matter allow water molecules to oxidize some of the iron in those spots.

Welding and passivation of the boost tank preferably meet standards set forth by ASTM A 967 and AMS 2700 or better. The processes defined in these specifications have been used typically to dissolve metallic elements from the surfaces of corrosion resistant steels to improve their corrosion resistance, but usage is not limited to such applications. These industry standards list several typical “types” of passivation processes that can be used, and refers to either the use of a nitric acid-based passivating bath, or a citric acid based bath. The various difference between methods refer to differences in acid bath temperature and concentration.

A high pressure boost system according to preferred embodiments is schematically illustrated in FIG. 5. The system is illustrated in its pressurization mode and comprising a tank 1 in which pressurized oxidizing agent and water, such as DI water is contained.

The system also comprising an injector 2 having a liquid inlet 6 for inletting pressurized liquid into the injector, an injector suction port 3 for inletting oxidizing gas into the injector, and an outlet port 7 connected to the tank 1 for outletting the pressurized liquid (water) and oxidizing agent such as ozone into the tank 2.

The system also comprising a pump 9 adapted to pressure a fluid to a pressure above 43.5 psi (3.0 bar) and having a pump inlet 10 in fluid connection with the interior of the tank 2. The pump has a pump outlet 11 in fluid connection with the liquid inlet 6 of the injector 2.

The tank 2 further comprising a pressurized oxidizing gas outlet 12 for outletting pressurized oxidizing gas from the tank 2. The oxidizing gas outlet 12 is preferably arranged at an upper end of the tank 2.

As illustrated in FIG. 5, it is preferred that the fluid being pressurized by the pump is taken from lower end the tank 2 and the pressurized oxidizing agent is introduced into tank 2 at and upper end thereof.

As also illustrated, the system further comprising a water inlet 13 for inletting water, preferably deionized water into system. Thus, during use of the system, water leaves the system with the pressurized oxidizing agent through the pressurized oxidizing gas outlet 12 and in order to keep water in the system, liquid such as DI-water is added through the water inlet 13. Advantageously, the water inlet 13 being provided in the tank 2 for inletting water, preferably deionized water into the tank 2 and thereby into the system.

A system according to present invention, may preferably further comprise a connection pipe 14 for feeding pressurized oxidizing agent to a well, and the pressurized oxidizing gas outlet 12 is in fluid communication with the connection pipe 14. Thus, the connection pipe 14 typically connects the pressurized oxidizing agent outlet 12 with the injection well.

A valve 5, such as a shut-off valve, may be arranged in the fluid connection between the connection pipe 14 and the pressurized gas outlet 12 for controlling the flow of pressurized oxidizing agent from the tank 2 and to the connection pipe 14.

Further, the connection pipe 14 may be in fluid communication with a source of oxidizing agent through a valve 4 such as a shut-off valve, for controlling a flow of oxidizing agent directly into the connection pipe 14.

Thus, with reference to the embodiment illustrated in FIG. 5, the valves 4 and 5 may be used to control whether or to which extend the oxidizing agent goes into the injector 3 or whether the injector is by-passed so that the oxidizing agent flows directly from the source to the well through the connection pipe 14.

The system preferably further comprises a mass controller 16 configured to operate the opening position of the valve 5 arranged in the fluid connection between the connection pipe 14 and the pressurized gas outlet 12. The mass controller preferably stacks on top of the valve 5 and is configured to sense flow through the valve and actuate the valve 5 to various positions to achieve desired final output. The mass controller preferably comprises a computer such as a PLC.

As disclosed herein, it may be advantageously to control the temperature in the system and to this, the system may further comprise a heat exchanger 8 for extracting or addition of heat to fluid present in the system, the heat exchanger being preferably arranged inside the tank 2.

A High pressure boost system according to the present invention preferably has a basic operational sequence including:
1. As part of a total ozone solution, it is assumed here that the ozone generation system is properly designed, operational, and programmed to be in automatic mode. Once confirmed, proceed to program desired injection wells and duration of injection per well.
2. Set up each projected injection well with desired oxidizing gas (compressed air, compressed oxygen, compressed air and ozone).
3. Set up each projected injection well with desired duration. This is variable for each well.
4. Fill Boost tank to required level with DI or RO (reverse osmotic water) non-contaminated water:
   a. This occurs through the use of a secondary water addition vessel which is connected to a tank level sensor and will add water until the boost tank level is full.
   b. Secondary water tank (not shown in the figures) is connected to the Boost tank 2 via a pneumatically controlled valve to control re-filling the water level in Boost tank 2. The secondary water tank also has a drain/exhaust valve for de-pressurizing and has an inlet for water and an inlet for compressed air.
   c. Water enters this secondary tank when a different valve opens letting pure water enter by means of a small water pump.
   d. After water has filled the secondary tank, the compressed air addition starts boosting up the pressure inside this secondary tank until it is slightly greater than the pressure inside the Boost Tank.
   e. Valve opens between Boost tank and secondary water tank allowing pressurized water to re-fill what has been lost due to saturated gas leaving the tank.
   f. Expected interval for Boost tank auto re-fill, once per day during continuous operation.
5. The user defined target flow rate is set in the (HMI) program screens for each of the wells desired flow rates. This is determined prior to system start up.
6. Start system automatic run mode.
7. Circulation pump (9 in FIG. 5) automatically starts and ozone generator starts producing ozone gas, which is fed to Mazzei injector suction port.
8. Operation starts by using only circulation pump (9 in FIG. 5) and Mazzei injector to enable the boost tank to reach its maximum possible pressure as determined during design phase.
9. Initially the boost tank only accepts ozone gas from the Mazzei injector:
   a. Since the actual flow rates accepted by individual wells can vary—additional air flow (above the maximum flow ozone generator can provide alone) will be made up from adding in compressed air at pressures up to 500 psi (34.5 bar) directly into the boost tank.
   b. Boost tank outlet valve (5 in FIG. 5) starts to open to achieve flow rate set point. If the boost tank outlet (control) valve opens 100% without achieving target flowrate set point—electronically-controlled compressed air regulator 15 begins adding pressure into the boost tank.
10. For every 5 seconds elapsed while not achieving target flow rate—compressed air will increase pressure by preset psi point (typically 1 psi)—and continues addition pressure for every 5 seconds thereafter until target flow rate is achieved.
11. When actual flow rate is equal or greater than target flow rate, compressed air regulator 15 stops adding (increasing air pressure) and maintains specified pressure.
12. Boost tank outlet valve now begins closing down from 100% to some partially open setting (between 5-99%) to lower back down to target flow rate—because the actual flow rate may exceed target flow rate by some amount, this valve will throttle down flow incrementally.
13. Back pressure on each individual well typically varies and also fluctuates over time. Typically a well will accept targeted flow rates easier and faster over time and it requires less compressed air gas flow/pressure addition, if any is needed at all.
14. If actual flow rate stays above target flow rate, boost tank outlet valve continues to close (while keeping the compressed air pressure regulator 15 at the same pressure) and continues to close down (if still above target flow rate) until boost tank outlet valve reaches 5% open—it's minimum setting.
   c. If boost tank outlet valve reaches 5% open—and actual flow rate is STILL above target flow rate, compressed air regulator 15 starts lowering pressure 1 psi every 5 seconds actual flow rate stays above target flow rate.
   d. This keeps on dropping pressure 1 psi (0.07 bar) every 5 seconds until actual flow rate is below target flow rate.
15. Steps 2-14 usually take 2-3 minutes per well to balance out (at the beginning) and adjust to meet target flow rate at each well. Therefore we recommend starting with a minimum 15 minute injection well sequence.
16. After 1^{st} run through the wells, the PLC program will “learn” the last known pressure and outlet valve setting and begin (pick back up from where it left off) re-adjusting from that previous known set point. On the 2^{nd} run through the wells, the system will reach the specified flow rate and pressure much more efficiently.

As presented herein, the system is controlled by a computer typically in combination with sensors e.g. pressure sensors, temperature sensors and sensors that detect other parameters and the control is typically so that the sensed parameters are to be with pre-defined limits. Typically, the control is carried out by PLC configured to carry out the operational sequence to be followed as outlined herein.

The choice of material for the various elements and parts of the system is selected according to its function so as to e.g. withstand the physical and chemical conditions during standstill and use of the system.

### LIST OF REFERENCE SYMBOLS USED

1 Injector (or eductor which is used interchangeably with “injector”)
2 (Boost) Tank (or water vessel)
3 Injector suction port
4 Valve
5 Valve (Boost tank outlet valve)
6 Water/Liquid inlet port (of injector)
7 Outlet port (of injector)
8 Heat exchanger
9 Pump
10 Pump inlet
11 Pump outlet
12 Pressurized oxidizing gas outlet
13 DI Water inlet connection pipe
14 Connection pipe
15 Air pressure regulator
16 Mass control

### REFERENCES CITED

U.S. Patent Documents

| | | |
|---|---|---|
| 5,221,159 | Jun. 22, 1993 | Billings et al. |
| 8,302,939 | Nov. 6, 2012 | Kerfoot |

### OTHER REFERENCES

“Concentrated Oxygen—Ozone Mixtures Stability at High Pressures”, B. Armengaud et al., Ozonia LTD, pp. 1-15.
“Ozone, O3, Physical properties, safety, MSDS, enthalpy, material compatibility, gas liquid equilibrium, density, viscosity, flammability, transport properties” Air Liquide, http://encyclopedia.airliquide.com/Encyclopedia.asp?GasID=137, February 2016, pp. 1-3.
“120 g cutsheet” PTI, http://www.plasmatechnics.com/pti %20detail_70227.html. March 2016.
“The Kinetics of Ozone Decomposition in Water, the Influence of pH and Temperature”, B. G. Ershov, P. A. Morozov, Franklin Institute of Physical Chemistry and Electrochemistry, Russian Academy of Sciences. March 2008, pp. 1-2.

1. An injection well high pressure oxidizing gas sparging method for in situ sparging for remediation or chemical degradation and removal of contaminants in soil and groundwater, comprising: delivering an oxidizing multi-gas into a well screen.

2. The method of claim 1, further comprising: coupling an inlet port to the well screen.

3. The method of claim 2, further comprising: coupling a boost tank's off-gas to inlet port on the well screen, interconnected by a length of riser piping and intermediate piping.

4. The method of claim 3, further comprising: coupling an ozone generator to supply ozone gas to an injector, or a Mazzei injector, circulating DI water in a boost tank; and coupling an air compressor to supply compressed ambient air to the boost tank.

5. The method of claim 4, further comprising: arranging the ozone generator and the air compressor so that the ozone generator gas supply is the primary gas source, the compressed ambient air is only added, in limited quantities, as a buffer to balance the fluctuations in wellfield backpressures.

6. The method of claim 5, further comprising supplying the ozone at a flow rate of 0.1-43.3 CFM (2600 CFH or 1227 LPM) at 0 to 43.5 psi (0-3 bar) into the injector, or the Mazzei injector, which has water outlet pressure of 500 psi (34.5 bar) into the boost tank and supplying compressed air at a flow rate of 0.1-21.65 CFM (1300 CFH or 613 LPM) at up to 500 psi (34.5 bar) into the boost tank.

7. The method of claim 1, wherein ozone mixed with oxygen and compressed ambient air form multi-gas, at a well site.

8. The method of claim 1, further comprising: disposing the well screen into a well that is contaminated.

9. The method of claim 6, wherein each boost tank and the injector, or the Mazzei injector system is configured to handle up to 8 CFM (480 CFH or 226.5 LPM) of total gas flow each and when needed, wherein multiple boost tanks and injectors or Mazzei injectors will be used in parallel to achieve targeted flow rates.

10. The method of claim 8, further comprising: disposing the well screen into a well at a depth in excess of 1100 feet (335 meters) below ground surface or with backpressure greater than 44 psi (3.03 bar) requiring output above gas generator manufactures rated 0 to 43.5 psi (0-3 bar).

11. The method of claim 8, further comprising: applying the method on multiple injection wells.

12. The method of claim 1, further comprising emitting multi-gas through the well screen small openings into an aquifer.

13. The method of claim 1, wherein the oxidizing gas is ozone.

14. The method of claim 1, wherein the oxidizing gas is oxygen.

15. The method of claim 3, wherein the boost tank incorporates internal cooling coils to maintain acceptable water temperatures to increase ozone solubility and reduce ozone decomposition due to elevated temperatures.

16. The method of claim 3, wherein the boost tank incorporates an external cooling jacket to reduce water temperatures to increase ozone solubility and reduce ozone decomposition due to elevated temperatures.

17. The method of claim 3, wherein the boost tank incorporates internal demisting-baffles to reduce moisture carry over from saturated-gas leaving tank through boost tank outlet valve.

18. The method of claim 3, wherein the boost tank incorporates automatic DI water addition when the boost tank water level is low.

19. The method of claim 3, wherein the boost tank incorporates an acid rinse and passivation of all welds during its construction.

20. The method of claim 4, wherein the injector, or the Mazzei injector, mixes ozone gas into DI water until the water is fully saturated with ozone gas, resulting in off-gassing any additional ozone at the pressure of the ozone saturated DI-water inside the boost tank.

21. A system for pressurizing an oxidizing agent, or ozone and/or oxygen, to a pressure above 43.5 psi (3.0 bar), the system comprising:
a tank;
an injector having:
a liquid inlet for inletting pressurized liquid into the injector,
an injector suction port for inletting oxidizing gas into the injector, and
an outlet port connected to the tank for outletting the pressurized liquid and oxidizing agent, such as ozone, into the tank; and
a pump adapted to pressure a fluid to a pressure above 43.5 psi (3.0 bar) and having:
a pump inlet in fluid connection with the interior of the tank, and
a pump outlet in fluid connection with the liquid inlet of the injector,
wherein the tank further comprises a pressurized oxidizing gas outlet for outletting pressurized oxidizing gas from the tank.

22. The system according to claim 21, wherein the system further comprises a water inlet for inletting water, deionized water or reverse osmotic water into the system.

23. The system according to claim 22, wherein the water inlet connection pipe is provided in the tank for inletting water, deionized water or reverse osmotic water into the tank.

24. The system according to claim 21, further comprising a connection pipe for feeding pressurized oxidizing agent to a well, and the pressurized oxidizing gas outlet is in fluid communication with the connection pipe.

25. The system according to claim 24, further comprising a valve, or a shut-off valve, arranged in the fluid connection between the connection pipe and the pressurized gas outlet for controlling the flow of pressurized oxidizing agent from the tank and to the connection pipe.

26. The system according to claim 24, wherein the connection pipe is in fluid communication with the with a source of oxidizing agent through a valve or a shut-off valve, for controlling a flow of oxidizing agent directly into the connection pipe.

27. The system according to claim 21, wherein the system further comprises a heat exchanger for extracting or adding heat to a fluid present in the system, the heat exchanger being arranged inside the tank.

28. The system according to claim 26 further comprising a mass controller configured to operate the opening position of the valve arranged in the fluid connection between the connection pipe and the pressurized gas outlet, the mass controller being configured to sense flow through the valve and actuate the valve to various positions to achieve desired final output.
